(19) United States
(12) Patent Application Publication
(10) Pub. No.: US 2025/0025724 A1
(43) Pub. Date: Jan. 23, 2025

(54) METHOD FOR MONITORING THE OCCURRENCE OF FIRE IN AN ENGINE

(71) Applicant: AIRBUS OPERATIONS SAS, Toulouse (FR)

(72) Inventor: Antoine PILON, Toulouse (FR)

(73) Assignee: AIRBUS OPERATIONS SAS, Toulouse (FR)

(21) Appl. No.: 18/775,921

(22) Filed: Jul. 17, 2024

(30) Foreign Application Priority Data
Jul. 18, 2023 (FR) 2307709

(51) Int. Cl. A62C 3/06; A62C 2/04; A62C 3/08

(52) U.S. Cl. CPC A62C 3/06; A62C 2/04; A62C 3/08

(57) ABSTRACT

A method for monitoring an engine of an aircraft supplied with dihydrogen, comprising a safety device including a safety valve that is movable between an open position in which the engine is supplied with dihydrogen and a closed position in which the engine is no longer supplied with dihydrogen, an engine fire detection system, a dihydrogen leak detection system and an engine damage detection system, and comprising electronic circuitry adapted to implement the monitoring method. If a locking authorization is given and if one out of three conditions A, B and C is true, then the safety device closes the safety valve, with: the condition A is true if an engine fire detection system detects a fire, the condition B is true if a dihydrogen leak detection system detects a dihydrogen leak, and the condition C is true if an engine damage detection system detects engine damage.

### TECHNICAL FIELD

The invention relates to the field of the monitoring of the occurrence of a fire in a turbomachine, of an aircraft, supplied with dihydrogen.

### STATE OF THE PRIOR ART

As is known, a turbomachine of an aircraft comprises a plurality of fire detection sensors connected to a monitoring device (of FDU type, FDU being the acronym for fire detection unit) that are configured to transmit a fire alert message upon the detection of a fire in the turbomachine.

On receiving a fire alert message, the crew has to focus on putting in place fire countermeasures, such as, for example, triggering anti-fire devices or reducing the thrust of the turbomachine. Documents that can for example be cited include FR3068392 and FR3052747 which describe a turbomachine fire monitoring device and method.

Such means for detecting the occurrence of a fire on a turbomachine are effective but are not suited to a turbomachine operating with dihydrogen. Indeed, the fire precursor signals are not necessarily the same as for a turbomachine operating with diesel fuel. Furthermore, the use of dihydrogen necessitates a faster reaction putting in place fire countermeasures.

In addition, it is also desirable for the fire countermeasures to be effective even when the fire or a dihydrogen leak results from an uncontained engine failure, also called UERF (Uncontained Engine Rotor Failure).

In this context, it is desirable to provide a method for monitoring an engine of an aircraft supplied with dihydrogen, which allows an automated countermeasure to be put in place in the event of detection of a risk of fire in the engine.

### SUMMARY OF THE INVENTION

To this end, according to a first aspect, a method for monitoring an engine of an aircraft supplied with dihydrogen is proposed, comprising a safety device comprising a safety valve that is movable between an open position in which the engine is supplied with dihydrogen and a closed position in which the engine is no longer supplied with dihydrogen, an engine fire detection system, a dihydrogen leak detection system and an engine damage detection system, and comprising electronic circuitry adapted to implement the monitoring method. If a locking authorization is given and if one out of three conditions A, B and C is true, then the safety device closes the safety valve, with:
the condition A is true if an engine fire detection system detects a fire,
the condition B is true if a dihydrogen leak detection system detects a dihydrogen leak, and
the condition C is true if an engine damage detection system detects engine damage.

According to one embodiment, the condition B is true if one of the two conditions B1 or B2 is true, with:
the condition B1 is true if a dihydrogen pressure less than a predetermined threshold is detected by the dihydrogen leak detection system;
the condition B2 is true if at least one of the following conditions is met: a dihydrogen concentration greater than a predetermined threshold is detected by the dihydrogen leak detection system; or a break of a dihydrogen supply line is detected by the dihydrogen leak detection system; or a pressure in the engine greater than a predetermined pressure is detected by the dihydrogen leak detection system; or a temperature variation greater than a predetermined temperature variation is detected by the dihydrogen leak detection system.

According to one embodiment, the condition B is true if the two conditions B1 and B2 are true.

According to one embodiment, the condition A is true if two conditions A1 and A2 are true, with:
the condition A1 is true if a fault of a fire detection loop is detected by the fire detection system;
the condition A2 is true if the fire detection system detects a fire.

According to one embodiment, the condition A is true if the two conditions A1 and A2 are true within a predetermined time interval.

According to another aspect, a safety device of an engine supplied with dihydrogen is proposed which comprises:
a safety valve that is movable between an open position in which the engine is supplied with dihydrogen and a closed position in which the engine is no longer supplied with dihydrogen;
an engine fire detection system;
a dihydrogen leak detection system;
an engine damage detection system; and
electronic circuitry adapted to implement a monitoring method in which, if a locking authorization is given and if one of the at least three conditions A or B or C is true, then the safety device closes the safety valve, with:
the condition A is true if an engine fire detection system detects a fire,
the condition B is true if a dihydrogen leak detection system detects a dihydrogen leak, and
the condition C is true if an engine damage detection system detects engine damage.

According to one embodiment, the fire detection system comprises a fire detection loop and a fire detector.

According to one embodiment, the dihydrogen leak detection system comprises an element chosen from among a line break detector, a dihydrogen pressure detector, a detector of pressure in the engine, and/or a temperature variation detector.

According to another aspect, an aircraft is proposed comprising a safety device according to the invention.

According to another aspect, a computer program product is proposed comprising program code instructions for executing the monitoring method according to the invention, when said instructions are executed by at least one processor.

According to another aspect, a non-transient storage medium is proposed on which is stored a computer program comprising program code instructions for executing the monitoring method according to the invention, when said instructions are read from said non-transient storage medium and executed by a processor.

### BRIEF DESCRIPTION OF THE DRAWINGS

The features of the invention mentioned above, and others, will become more clearly apparent on reading the following description of at least one exemplary embodiment, said description being given in relation to the attached drawings, in which:

FIG. 1 schematically illustrates the set-up of a monitoring device in an engine;

FIG. 2 schematically illustrates a computing system;

FIG. 3 schematically illustrates a monitoring method according to a first embodiment;

FIG. 4 schematically illustrates a monitoring method according to a first embodiment; and

FIG. 5 schematically illustrates an aircraft comprising an engine and a safety device.

### DETAILED EXPLANATION OF EMBODIMENTS

### Safety Device

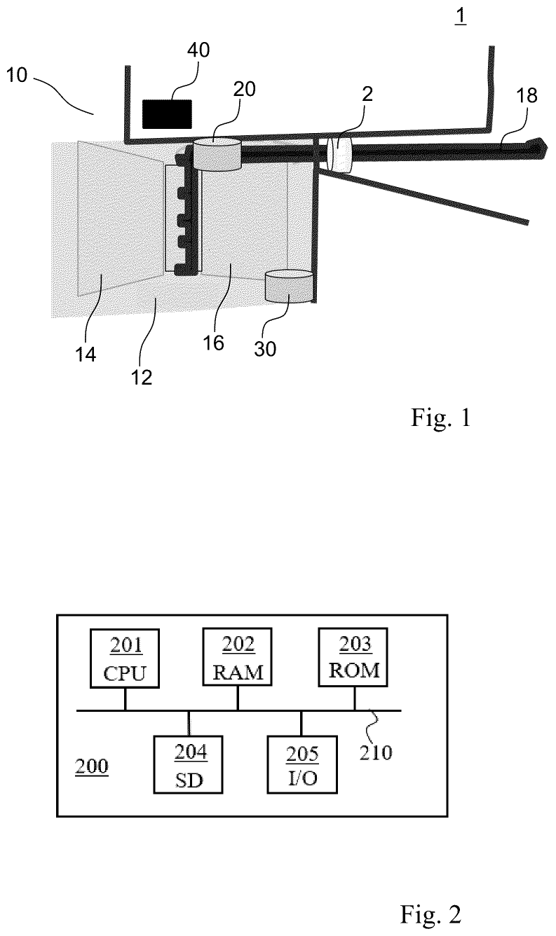

Referring to FIG. 1, according to one aspect, a safety device 1 of an engine 10 supplied with dihydrogen is proposed. The safety device 1 is adapted to be installed in and around the engine 10, to monitor the risks of fires in the engine 10.

The safety device 1 comprises a safety valve 2 that is movable between an open position in which the engine 10 is supplied with dihydrogen and a closed position in which the engine 10 is no longer supplied with dihydrogen.

As schematically represented in FIG. 1, according to one embodiment, the safety valve 2 is positioned outside of a combustion zone 12 of the engine 10. Indeed, as schematically represented in FIG. 1, the engine 10 is a turbomachine, comprising a combustion zone 12 in which compressors 14 and turbines 16 are situated. This turbomachine architecture is moreover well known.

On the other hand, in a particularly shrewd way, the safety valve 2 is positioned outside of the combustion zone 12 so as to be able to act on (i.e. stop) the supply of dihydrogen (i.e. the lines 18) upstream of the combustion zone 12.

Advantageously, the combustion zone 12 considered includes all of the zones around the engine 10 in which debris from the engine 10 is likely to be sprayed in the event of an uncontained engine failure. Thus, since the safety valve 2 is positioned outside of the combustion zone 12, the safety valve 2 does not risk being impacted in the event of an uncontained engine failure.

According to one embodiment, the safety valve 2 is positioned outside of the combustion zone 12, while being as close as possible to the combustion zone 12. This disposition makes it possible to minimize the quantity of dihydrogen that can still circulate in the lines 18 after the safety valve 2 has switched to closed position.

In addition to the safety valve 2, the safety device 1 also comprises: an engine fire detection system 30, a dihydrogen leak detection system 20, and an engine damage detection system 40.

According to one embodiment, the engine fire detection system 30 comprises a fire detection loop and a fire detector. The fire detection loop and the fire detector are known elements. Typically, the fire detection loop is a line filled with a gas. When the heat increases around the line (i.e. when there is a fire around the line) the gas expands. An expansion sensor associated with the line detects the expansion and emits a fire detection signal.

According to one embodiment, the dihydrogen leak detection system 20 comprises a line break detector, a dihydrogen pressure detector, a detector of pressure in the engine, and a temperature variation detector.

According to one embodiment, the line break detector operates by measuring a dihydrogen pressure in the dihydrogen line. In the event of a line break, the pressure varies to tend towards atmospheric pressure. If the detector senses a pressure in the line close to atmospheric pressure, it emits a dihydrogen line break detection signal.

According to one embodiment, the detector of pressure in the engine is a detector of ambient pressure in the engine. In the event of variation of the ambient pressure, the detector emits an ambient pressure variation detection signal.

According to one embodiment, the temperature variation detector can comprise a thermocouple or an optical sensor. According to one embodiment, the temperature variation detector can emit a temperature variation detection signal if a measured temperature is situated outside of a predetermined interval. According to another embodiment, the temperature variation detector is adapted to detect an abrupt change of temperature, that is to say a change of temperature greater than a predetermined threshold, over a predetermined time.

According to one embodiment, the engine damage detection system 40 is a system that is known, for example from the documents FR3068392 and FR3052747, which will not be described in the present document.

According to other embodiments, some of the detectors previously stated may be absent.

### Computing System

In addition, the safety device 1 comprises electronic circuitry adapted to implement a monitoring method 100 which will be described hereinbelow.

Thus, according to another aspect, a computing system 200 is proposed comprising electronic circuitry configured to implement a monitoring method 100.

As schematically represented in FIG. 2, the computing system 200 can comprise, linked by a communication bus 210: a processor 201; a random-access memory 202; a read-only memory 203, for example of ROM (Read-Only Memory) or EEPROM (Electrically Erasable Programmable Read-Only Memory) type; a storage unit 204, such as a hard disk HDD (Hard Disk Drive), or a storage medium reader, such as an SD (Secure Digital) card reader; and an input-output interface manager 205.

The processor 201 is capable of executing instructions loaded into the random-access memory 202 from the read-only memory 203, from an external memory, from a storage medium (such as an SD card), or from a communication network. When the computing system 200 is powered up, the processor 201 is capable of reading instructions from the random-access memory 202 and of executing them. These instructions form a computer program allowing the implementation, by the processor 201, of the monitoring method 100 described hereinbelow.

All or part of the method 100 can thus be implemented in software form by the execution of an instruction set by a programmable machine, for example a processor of DSP (Digital Signal Processor) type or a microcontroller, or be implemented in hardware form by a dedicated machine or component, for example an FPGA (Field Programmable Gate Array) or ASIC (Application-Specific Integrated Circuit) component. Generally, the computing system 200 comprises electronic circuitry adapted and configured to implement, in software and/or hardware form, the monitoring method 100 described hereinbelow in relation to the computing system 200 concerned.

### Aircraft

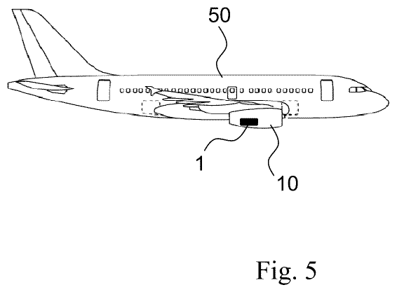

According to another aspect, as schematically represented in FIG. 5, an aircraft 50 is proposed comprising an engine 10 supplied with dihydrogen, and further comprising at least one safety device 1 and the computing system 200.

### Monitoring Method

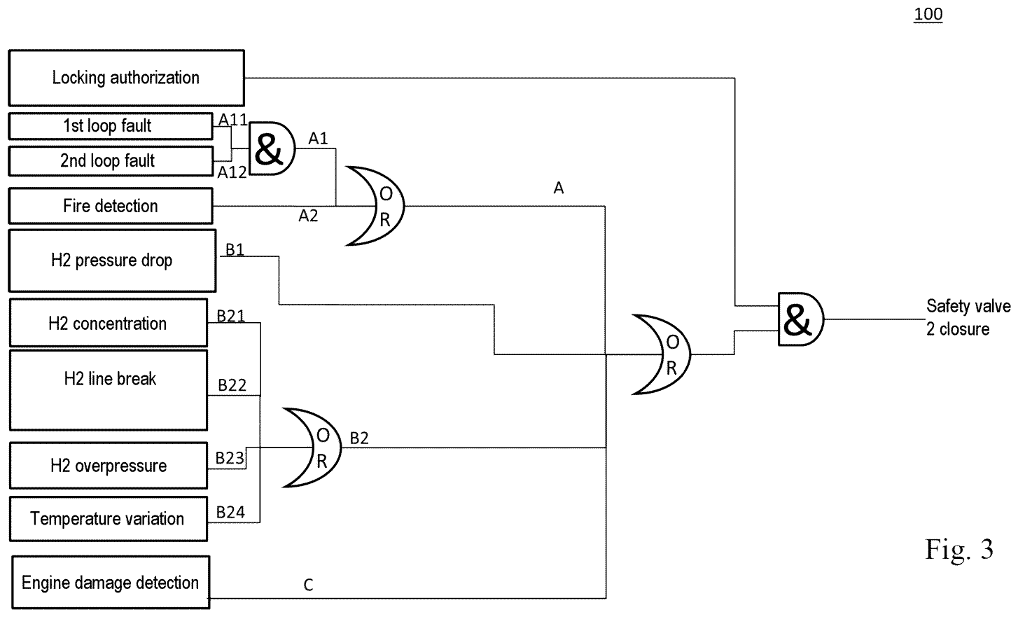

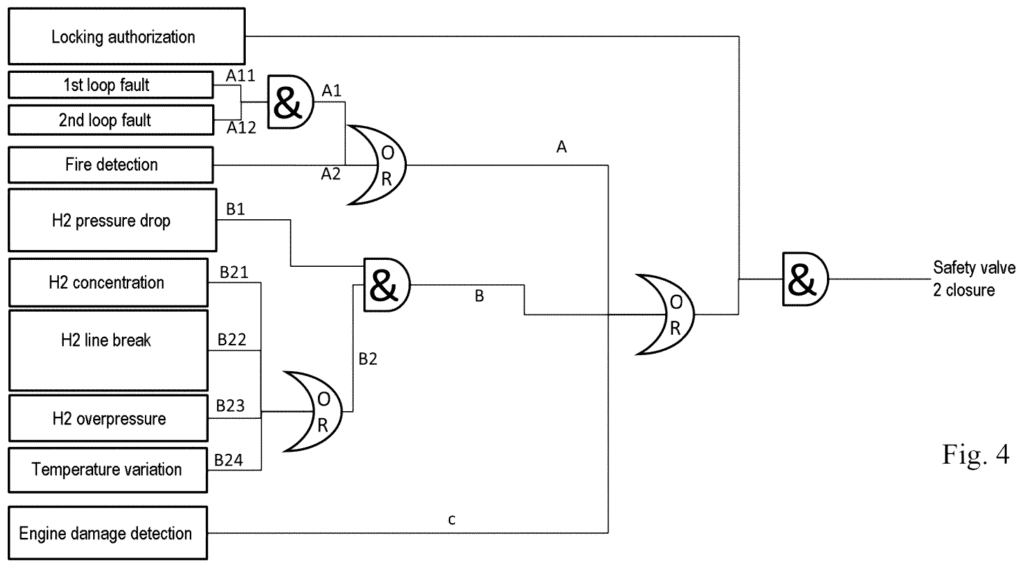

According to another aspect, referring to FIGS. 3 and 4, a method 100 is proposed for monitoring an engine 10 of the aircraft 50 supplied with dihydrogen.

Referring to FIGS. 3 and 4, if a locking authorization is given and if one of the at least three conditions A or B or C is true, then the safety device 1 closes the safety valve 2, with:
the condition A is true if an engine fire detection system 30 detects a fire,
the condition B is true if a dihydrogen leak detection system 20 detects a dihydrogen leak, and
the condition C is true if an engine damage detection system 40 detects engine damage.

According to one embodiment, the locking authorization is given according to criteria linked to the availability of another engine 10 of the aircraft 50, for example if a similar problem has not already been detected on the other engine of the aircraft and if the thrust of the other engine is available.

According to the embodiments schematically represented in FIGS. 3 and 4, the condition A is true if two conditions A1 and A2 are true, with:
the condition A1 is true if a fault of at least one fire detection loop is detected by the fire detection system 30 concerned;
the condition A2 is true if the fire detection system 30 concerned detects a fire.

In addition, according to a particular disposition, schematically represented in FIGS. 3 and 4, the condition A1 is true if two conditions A11 and A12 are true, with:
the condition A11 is true if a fault of a first fire detection loop is detected by the fire detection system 30 concerned;
the condition A12 is true if a fault of a second fire detection loop is detected by the fire detection system 30 concerned.

According to a particular disposition, the condition A1 is true if the two conditions A11 and A12 are true within a predetermined time interval, for example a time interval of 5 seconds.

According to an embodiment schematically represented in FIG. 3, the condition B is true if one of the two conditions B1 or B2 is true, with:
the condition B1 is true if a dihydrogen pressure less than a predetermined threshold is detected by the dihydrogen leak detection system 20;
the condition B2 is true if at least one of the following conditions is met: a dihydrogen concentration greater than a predetermined threshold is detected by the dihydrogen leak detection system 20 (condition B21); or if a break of a dihydrogen supply line is detected by the dihydrogen leak detection system 20 (condition B22); or if a pressure in the engine 10 greater than a predetermined pressure is detected by the dihydrogen leak detection system 20 (condition B23); or if a temperature variation greater than a predetermined temperature variation is detected by the dihydrogen leak detection system 20 (condition B24).

According to another embodiment schematically represented in FIG. 4, the condition B is true if at least the two conditions B1 and B2 are true.

According to one embodiment, the open or closed position of the valve 2 is indicated to a user on a display screen. Typically, this display screen can be a control screen in the cockpit of the aircraft 50. According to one embodiment, distinctive visual signals make it possible to inform a user as to the state of each detector of the safety device 1. Thus, according to this embodiment, if the valve 2 switches to closed position, the user is alerted and the different visual signals allow him or her to know the cause of the switch to closed position of the valve 2.

1. A Method for monitoring an engine of an aircraft supplied with dihydrogen, comprising a safety device comprising a safety valve that is movable between an open position in which the engine is supplied with dihydrogen and a closed position in which the engine is no longer supplied with dihydrogen, an engine fire detection system, a dihydrogen leak detection system and an engine damage detection system, and comprising electronic circuitry adapted to implement the monitoring method, the monitoring method comprising:
if a locking authorisation is given, the locking authorization is given according to criteria linked to the availability of another engine of the aircraft, and
if one out of three conditions A, B and C is true, then the safety device closes the safety valve, with:
the condition A is true if an engine fire detection system detects a fire,
the condition B is true if a dihydrogen leak detection system detects a dihydrogen leak, and
the condition C is true if an engine damage detection system detects engine damage.

2. The method for monitoring according to claim 1, wherein the locking authorisation corresponds to a locking authorisation given if one of the conditions A, B and C has not already been detected true for the other engine of the aircraft and if the thrust of the other engine is available

3. The method for monitoring according to claim 1, wherein the condition B is true if one of the two conditions B1 or B2 is true, with:
the condition B1 is true if a dihydrogen pressure less than a predetermined threshold is detected by the dihydrogen leak detection system;
the condition B2 is true if at least one of the following conditions is met: a dihydrogen concentration greater than a predetermined threshold is detected by the dihydrogen leak detection system; or a break of a dihydrogen supply line is detected by the dihydrogen leak detection system; or a pressure in the engine greater than a predetermined pressure is detected by the dihydrogen leak detection system; or a temperature variation greater than a predetermined temperature variation is detected by the dihydrogen leak detection system.

4. The method for monitoring according to claim 3, wherein the condition B is true if the two conditions B1 and B2 are true.

5. The method for monitoring according to claim 1, wherein the condition A is true if two conditions A1 and A2 are true, with:
the condition A1 is true if a fault of a fire detection loop is detected by the fire detection system;
the condition A2 is true if the fire detection system detects a fire.

6. A safety device of an engine supplied with dihydrogen, wherein the safety device comprises:
a safety valve that is movable between an open position in which the engine is supplied with dihydrogen and a closed position in which the engine is no longer supplied with dihydrogen;
an engine fire detection system;
a dihydrogen leak detection system;
an engine damage detection system; and
electronic circuitry adapted to implement a monitoring method in which, if a locking authorization is given, the locking authorisation being given according to criteria linked to the availability of another engine of the aircraft, and if one of the at least three conditions A or B or C is true, then the safety device closes the safety valve, with:
the condition A is true if an engine fire detection system detects a fire,
the condition B is true if a dihydrogen leak detection system detects a dihydrogen leak, and
the condition C is true if an engine damage detection system detects engine damage.

7. The safety device according to claim 6, wherein the fire detection system comprises a fire detection loop and a fire detector.

8. The safety device according to claim 6, wherein the dihydrogen leak detection system comprises an element chosen from among a line break detector, a dihydrogen pressure detector, a detector of pressure in the engine, and/or a temperature variation detector.

9. The aircraft comprising a safety device according to claim 6.

10. (canceled)

11. A non-transient storage medium on which is stored a computer program comprising program code instructions for executing method for monitoring according to claim 1, when said instructions are read from said non-transient storage medium and executed by a processor.
